(19) United States
(12) Patent Application Publication
(10) Pub. No.: US 2014/0184593 A1
(43) Pub. Date: Jul. 3, 2014

(54) SYSTEM AND METHOD OF STORING OBJECT INFORMATION AS PREDEFINED ISLAND ARTIFACTS IN THE CAD MODEL

(71) Applicant: FEDLABS, Coimbatore (IN)

(72) Inventors: Sojesh Somapalan, Coimbatore (IN); Karthika Ramalingam, Coimbatore (IN); Udayakumar Vasudevan, Coimbatore (IN)

(73) Assignee: FedLabs, Coimbatore (IN)

(21) Appl. No.: 13/856,433

(22) Filed: Apr. 3, 2013

(30) Foreign Application Priority Data
Dec. 29, 2012 (IN) 5506/CHE/2012

(51) Int. Cl. G06T 9/00

(52) U.S. Cl. CPC G06T 9/001
USPC 345/420

(57) ABSTRACT

A CAD model information encoder tool that allows encoding one or more parameters of an object in a three dimensional (3D) CAD model is provided. The CAD model information encoder tool includes (i) a memory unit that stores a) a database, and b) a CAD module, and (ii) a processor. The processor executes the CAD module to generate the 3D CAD model. The CAD module includes a) a header encoding module that uses one or more existing parameters to declare and encode one or more parameters in the 3D CAD model, and b) a body encoding module that encodes one or more object information related to the one or more parameters declared in a predefined island artifact of said three dimensional CAD model as a combination of said plurality of existing parameters. The database stores the 3D CAD model with predefined island artifacts.

### CROSS-REFERENCE TO RELATED APPLICATIONS

This application claims priority to Indian patent application no. 5506/CHE/2012 filed on Dec. 29, 2012, the complete disclosure of which, in its entirety, is herein incorporated by reference.

### BACKGROUND

1. Technical Field

The embodiments herein generally relate to storing properties of a computer-aided design (CAD) model, and, more particularly, a system and method to store object information such as coordinate system or other geometry as a predefined island artifact in the CAD model.

2. Description of the Related Art

Three dimensional file formats require proprietary algorithms to read information about the CAD model. As a result, the geometry may be stored in a way, which is different from an intended geometry in the CAD model. The open source three dimensional file formats like ply format and STL format store object information as simple vertices and faces. A three dimensional CAD model has a number of parameters (e.g., vertices, vertices fields, faces, color of vertices, curvature, normal of a face, etc.). The object information of the three dimensional CAD model are typically stored as two parts: (1) a header and (2) a body. The header states explicitly all parameters except physical properties of the 3D CAD model. A physical property may be height, weight, etc. and parameter is vertices, vertex color, etc.

The body of the file format has data of CAD model parameters. The data values are organized as per the header of the file format of the CAD model. The vertices in the body of the file format are represented as a collection of six numbers arranged in an order as per the header of the file format. The parameters of the three dimensional file formats do not reveal any information about the physical properties intended to be stored in CAD model.

Accordingly, the conventional CAD model file format such as .ply and .STL are not designed to store properties other than the intended properties like vertices and faces etc. The conventional CAD model file format becomes un-readable when new property information is stored in the file.

### SUMMARY

In view of a foregoing, an embodiment herein provides a CAD model information encoder tool that allows encoding one or more parameters of an object in a three dimensional CAD model. The CAD model information encoder tool includes (i) a memory unit that stores a) a database, b) a CAD module, and (ii) a processor. The processor executes the CAD module to generate the three dimensional CAD model. The database stores a) a header portion of the three dimensional CAD model that stores a number of one or more parameters declared in the three dimensional CAD model in addition to one or more existing parameters, and b) a body portion of the three dimensional CAD model that stores one or more object information related to the one or more parameters declared in the header portion. The CAD module includes a) a header encoding module that uses the one or more existing parameters to encode one or more parameters declared in the three dimensional CAD model, and b) a body encoding module that encodes one or more object information related to the one or more parameters declared in a predefined island artifact of the three dimensional CAD model as a combination of the one or more existing parameters. The CAD model information encoder tool further includes a display unit that is capable of displaying the one or more parameters and the one or more object information related to the one or more parameters encoded in the three dimensional CAD model. The one or more parameters are encoded in the predefined island artifact by including one or more vertices and/or one or more faces in the body portion of the three dimensional CAD model. The one or more object information related to the one or more parameters are encoded in the predefined island artifact by adding one or more data objects related to the one or more parameters in the body portion of the three dimensional CAD model. The predefined island artifact may be a tetrahedron artifact.

In another aspect, a CAD model information encoder tool that allows encoding one or more parameters of an object in a three dimensional CAD model is provided. The CAD model information encoder tool includes (i) a memory unit that stores a) a database, b) a CAD module, and (ii) a set of instructions. The processor executes the set of instruction to generate a three dimensional CAD model using the CAD module. The database stores a) a header portion of the three dimensional CAD model that stores a number of one or more parameters declared in the three dimensional CAD model in addition to one or more existing parameters, and b) a body portion of the three dimensional CAD model that stores one or more object information related to the one or more parameters declared in the header portion. The CAD module includes a) a header encoding module that uses the one or more existing parameters to encode one or more parameters declared in the three dimensional CAD model, and b) a body encoding module that encodes one or more object information related to the one or more parameters declared in a predefined island artifact of the three dimensional CAD model as a combination of the one or more existing parameters. The CAD model information encoder tool further includes a display unit that is capable of displaying the one or more parameters and the one or more object information related to the one or more parameters encoded in the three dimensional CAD model. The one or more parameters are encoded in the predefined island artifact by including one or more vertices and/or one or more faces in the body portion of the three dimensional CAD model. The one or more object information related to the one or more parameters are encoded in the predefined island artifact by adding one or more data objects related to the one or more parameters in the body portion of the three dimensional CAD model. The predefined island artifact may be tetrahedron artifact.

In yet another aspect, a method of encoding a plurality of parameters of an object in a three dimensional CAD model using a CAD model information encoder tool is provided. The method includes the following steps: a) generating, using a CAD module, a three dimensional CAD model. The CAD module includes a header encoding module and a body encoding module to encode one or more parameters in the dimensional CAD model. The method further includes b) including one or more vertices and/or one or more faces in a body portion of the three dimensional CAD model, c) encoding, using the header encoding module, one or more parameters declared in the three dimensional CAD model using one or more existing parameters, d) including one or more object information related to the one or more parameters in the body portion of the three dimensional CAD model, e) encoding, using the body encoding module, the one or more object information related to the one or more parameters in the predefined island artifact of the three dimensional CAD model, and f) displaying, by a display unit, the one or more parameters and the one or more object information related to the one or more parameters encoded in the three dimensional CAD model. The predefined island artifact of the three dimensional CAD model is stored in a database. The predefined island artifact may be a tetrahedron artifact.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a user system to store properties of an object in a three dimensional CAD model using a CAD model information encoder software according to an embodiment herein;

FIGS. 2A and 2B illustrate parts of the CAD information encoder software of FIG. 1 according to an embodiment herein;

FIG. 3A illustrates a three dimensional view of one or more vertices of an island artifacts of the CAD model of FIG. 1 according to an embodiment herein;

FIG. 3B illustrates a three dimensional view of one or more vertices and three faces of an island artifact of the CAD model of FIG. 1 according to an embodiment herein;

FIG. 3C illustrates a three dimensional view of a five vertices and six faces island artifact of the CAD model of FIG. 1 according to an embodiment herein;

FIG. 4 is a flow diagram illustrating a method of encoding information of an object in a CAD model using the CAD model information encoder software of FIG. 1 according to an embodiment herein; and

FIG. 5 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

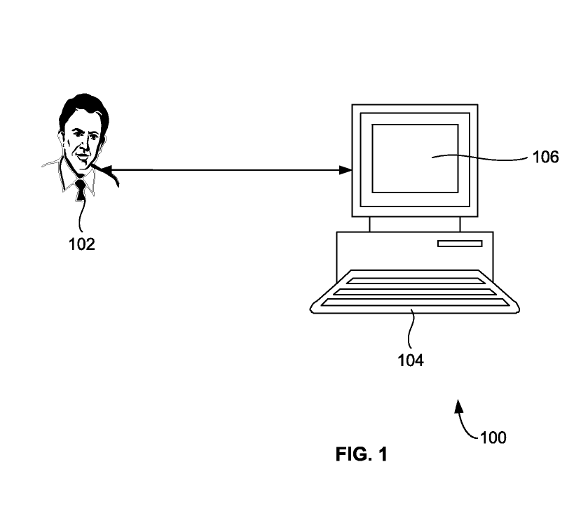

As mentioned, there remains a need for an information encoder system for storing more physical property information of an object in a CAD model. The embodiments herein achieve this by storing object information of a coordinate system as well as other geometry information (e.g., parameters) in a predefined island artifact of the CAD model. The coordinate system uses a standard parameter like vertex in a header of the CAD model and creating collection of vertices and faces to encode coordinate system information. The added vertices create island artifacts with encoded object information. Referring now to the drawings and more particularly to FIG. 1 through FIG. 5, where similar reference characters denote corresponding features consistently throughout the figures, there are shown preferred embodiments.

FIG. 1 illustrates a system view of a user 102 communicating with a user system 104 to store properties of an object in a three dimensional CAD model using a CAD model information encoder software 106 according to an embodiment herein. The CAD model information encoder software 106 provides a user interface to the user 102 to store the object information of the three dimensional CAD model in the user system 104. The CAD model information encoder software 106 allows the user 102 to store object information in a predefined island artifact of the three dimensional CAD model. The predefined island artifact is a part of three dimensional CAD model having one or more vertices and faces. The predefined island artifact in the CAD model information encoder software 106 encodes one or more physical properties (e.g., one or more parameters) of the objects to be stored in the three dimensional CAD model.

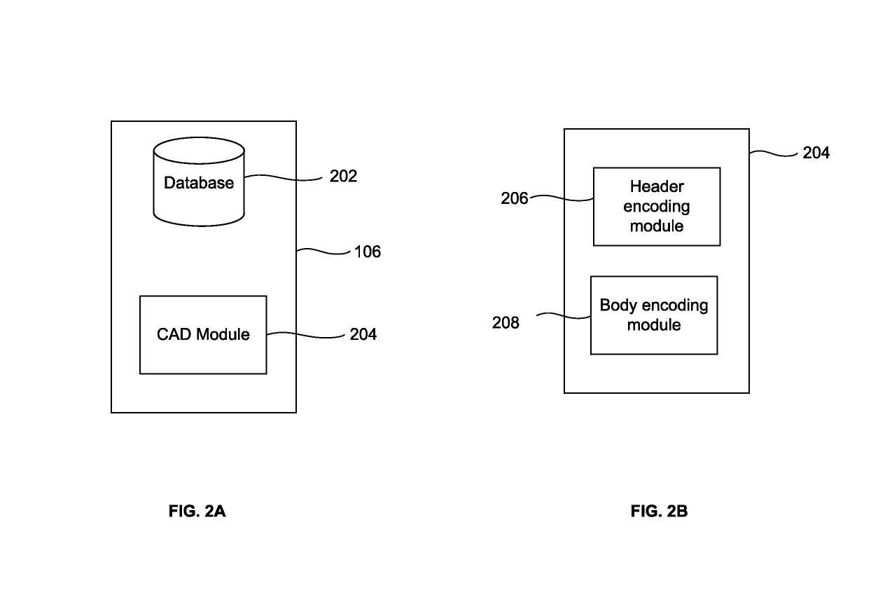

FIGS. 2A and 2B illustrate parts of the CAD information encoder software 106 of FIG. 1 according to an embodiment herein. The CAD model information encoder software 106 includes a database 202, and a CAD module 204. The CAD module 204 provides a CAD model of an object in three dimensional formats (e.g., a .ply format and/or a .STL format). The CAD module 204 includes a header encoding module 206 and a body encoding module 208 (shown in FIG. 2B). The header encoding module 206 encodes one or more parameters (e.g., property objects) such as type of parameter and total number of parameters (number of vertices, faces and color vertex) declared in the three dimensional CAD model. The body encoding module 208 encodes data objects such as axis values (x, y, z) and color information of the one or more parameters declared in the three dimensional CAD model. In one embodiment, the CAD information encoder software 106 allows the user 102 to add and/or read one or more parameters (e.g., property objects) to the conventional three dimensional CAD model in different file formats (e.g., a .ply format and/or a .STL format). In another embodiment, the CAD information encoder software 106 uses existing property objects (e.g., existing property objects are already defined in the conventional three dimensional CAD model in either proprietary or open source formats) in three dimensional CAD model to encode one or more property objects (i.e. parameter) in a predefined island artifact as a combination of existing property objects. The database 202 stores the three dimensional CAD model with predefined island artifacts.

The CAD information encoder software 106 allows the user 102 to encode one or more parameter by a) including one or more vertices and/or one or more faces, and b) by including one or more data objects in the body portion of the three dimensional CAD model. The CAD information encoder software 106 creates an island artifact with the CAD module 204 by increasing the number of vertices and faces in the header portion in the body portion of the three dimensional CAD model to encode object information (e.g., volume, weight and/or temperature, etc.) related to one or more parameters.

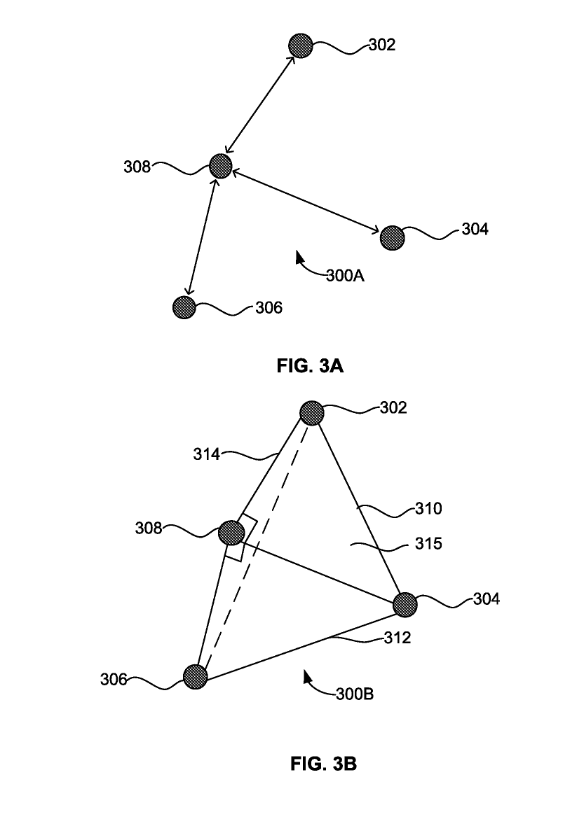

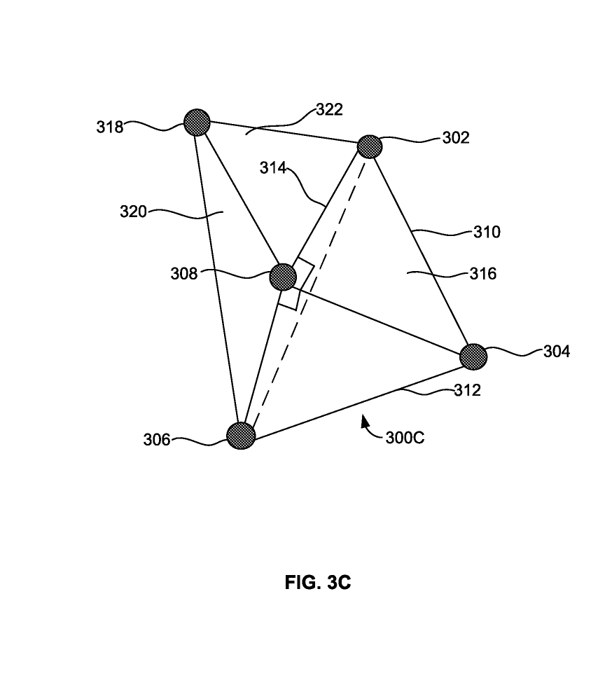

FIG. 3A illustrates a three dimensional view of one or more vertices of an island artifacts 300A of the CAD model of FIG. 1according to an embodiment herein. One or more vertices of island artifacts 300A include a first vertex 302, a second vertex 304, a third vertex 306, and a fourth vertex 308. The distance between the first vertex 302 and the fourth vertex 308 is a user defined value of the object information. The distance between the second vertex 304 and the fourth vertex 308 is a user defined value of the object information. The distance between the third vertex 306 and the fourth vertex 308 is a user defined value of object information. The first vertex 302, the second vertex 304, and the third vertex 306 are connected with the fourth vertex 308 through three separate lines. The three separate lines are perpendicular to each other.

FIG. 3B illustrates a three dimensional view of one or more vertices and three faces of an island artifact 300B of the CAD model of FIG. 1 according to an embodiment herein. The three dimensional view of one or more vertices and three faces of the island artifact 300B include four vertices and three faces. The four vertices of the island artifact 300B include the first vertex 302, the second vertex 304, the third vertex 306, and the fourth vertex 308. The four faces of the island artifact 300B include a first face 310, a second face 312, a third face 314 and a fourth face 316. The first face 310 is formed through one or more straight line connections that connect the first vertex 302 to the second vertex 304, the second vertex 304 to the fourth vertex 308, and the fourth vertex 308 to the first vertex 302. The second face 312 is formed through one or more straight line connections that connect the second vertex 304 to the third vertex 306, the third vertex 306 to the fourth vertex 308, and the fourth vertex 308 to the second vertex 304. The third face 314 is formed through one or more straight line connections that connect the first vertex 302 to the third vertex 306, the third vertex 306 to the fourth vertex 308, and the fourth vertex 308 to the first vertex 302. The fourth face 316 is formed through one or more straight line connections that connect the first vertex 302 to the third vertex 306, the third vertex 306 to the second vertex 304, and the second vertex 304 to the first vertex 302. In one embodiment, any of three vertices are joined to form a triangle shaped face.

With reference to FIG. 3B, FIG. 3C illustrates a three dimensional view of a five vertices and six faces island artifact 300C of the CAD model of FIG. 1 according to an embodiment herein. The island artifact 300C includes a fifth vertex 318, a fifth face 320, and a sixth face 322. The fifth vertex 318 connects through three separate lines from the first vertex 302, the third vertex 306, and the fourth vertex 308. The fifth face 320 is formed through one or more straight line connections that connect the third vertex 306, the fourth vertex 308, and the fifth vertex 318. The sixth face 322 is formed through one or more straight line connections that connect the first vertex 302, the fourth vertex 308, and the fifth vertex 318. The first four vertices (e.g., the first vertex 302, the second vertex 304, the third vertex 306, and the fourth vertex 308) provide an orthogonal shape for a coordinate system with the fourth vertex 308 as origin. The fourth vertex 308 is a hub of the orthogonal shaped island artifact. A straight line connection between the forth vertex 308 and the first vertex 302 is used to represent an x-axis. A straight line connection between the forth vertex 308 and the second vertex 304 is used to represent a y-axis. A straight line connection between the forth vertex 308 and the third vertex 306 is used to represent a z-axis. Together, the four vertices (e.g., the first vertex 302, the second vertex 304, the third vertex 306, and the fourth vertex 308) can be used to represent a xyz coordinate system and encodes an xyz coordinate orientation information using a collection of existing parameters like vertexes, faces, and/or color. The fourth vertex 308 and the fifth vertex 318 may be used to encode value of physical properties (e.g., mass, density and/or weight, etc.) of the CAD model. In one embodiment, the user 102 changes the distance between the vertices according to the value of physical properties. In another embodiment, the island artifact is a tetrahedron island artifact representing the coordinate system of the object.

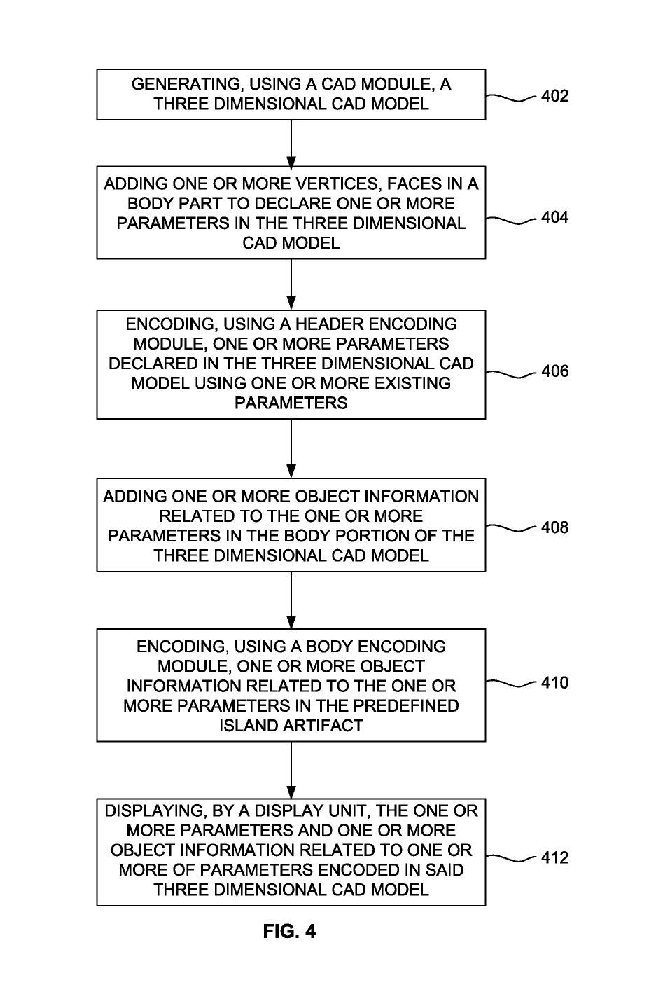

FIG. 4, with reference to FIGS. 1 through 3C, is a flow diagram illustrating a method of encoding information of an object in a three dimensional CAD model using the CAD model information encoder software 106 of FIG. 1 according to an embodiment herein. In step 402, a three dimensional CAD model is generated using the CAD module 204. The CAD module 204 includes the header encoding module 206 and the body encoding module 208 to encode one or more parameters in the three dimensional CAD model in addition to one or more existing parameters. In step 404, one or more vertices and/or one or more faces are added in a body portion of the three dimensional CAD model to declare one or more parameters in the three dimensional CAD. In step 406, the one or more parameters declared in the three dimensional CAD model are encoded by the header encoding module 206 using the one or more existing parameters. In step 408, one or more object information related to the one or more parameters are added in the body portion of the three dimensional CAD model. In step 410, the body encoding module 208 encodes one or more object information related to the one or more parameters in a predefined island artifact of the three dimensional CAD model. In step 412, the one or more parameters and the one or more object information related to the one or more parameters encoded in the three dimensional CAD model are displayed by a display unit. In one embodiment, the three dimensional CAD model with the predefined island artifact is stored in the database 202.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

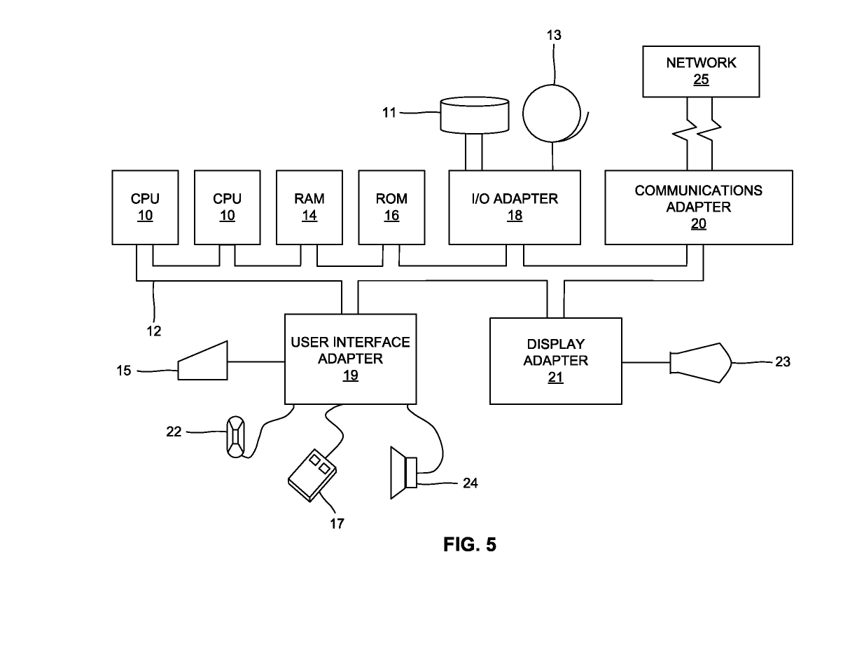

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

This CAD model information encoder software 106 allows the user 102 to store properties and/or parameters other than the intended properties like vertices and faces etc. in 3D CAD model file format such as .ply and .STL using the predefined island artifact. The 3D CAD model file format becomes readable when new property information is stored in the 3D CAD model.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A CAD model information encoder tool that allows encoding a plurality of parameters of an object in a three dimensional CAD model, said CAD model information encoder tool comprising:
a memory unit that stores a database and a CAD module, wherein said database stores a) a header portion that stores a number of said plurality of parameters declared in said three dimensional CAD model in addition to a plurality of existing parameters, and b) a body portion that stores a plurality of object information related to said plurality of parameters declared in said header portion;
a processor that executes said CAD module that is configured to generate said three dimensional CAD model, said CAD module comprising:
a header encoding module that uses said plurality of existing parameters to encode said plurality of parameters declared in said three dimensional CAD model; and
a body encoding module that encodes said plurality of object information related to said plurality of parameters declared in a predefined island artifact of said three dimensional CAD model as a combination of said plurality of existing parameters; and
a display unit that is capable of displaying said plurality of parameters and said plurality of object information related to said plurality of parameters encoded in said three dimensional CAD model.

2. The CAD model information encoder tool of claim 1, wherein said plurality of parameters are encoded in said predefined island artifact by including a plurality of vertices and a plurality of faces in said body portion.

3. The CAD model information encoder tool of claim 1, wherein said plurality of object information related to said plurality of parameters are encoded in said predefined island artifact by adding a plurality of data objects related to said plurality of parameters in said body portion.

4. The CAD model information encoder tool of claim 1, wherein said predefined island artifact is a tetrahedron artifact.

5. A CAD model information encoder tool that allows encoding a plurality of parameters of an object in a three dimensional CAD model, said CAD model information encoder tool comprising:
a memory unit that stores a database and a set of instructions, wherein said database stores a) a header portion that stores a number of said plurality of parameters declared in said three dimensional CAD model in addition to a plurality of existing parameters, and b) a body portion that stores a plurality of object information related to said plurality of parameters declared in said header portion; and
a processor that executes said set of instructions, in a CAD module, comprising:
a) generating, at said CAD module, said three dimensional CAD model, wherein said CAD module comprising;
(i) a header encoding module that uses said plurality of existing parameters to encode said plurality of parameters declared in said three dimensional CAD model; and
(ii) a body encoding module that encodes said plurality of object information related to said plurality of parameters declared in a predefined island artifact of said three dimensional CAD model as a combination of said plurality of existing parameters; and
b) displaying, by a display unit, said plurality of parameters and said plurality of object information related to said plurality of parameters of said three dimensional CAD model.

6. The CAD model information encoder tool of claim 5, wherein said plurality of parameters are encoded in said predefined island artifact by including a plurality of vertices and a plurality of faces in said body portion.

7. The CAD model information encoder tool of claim 5, wherein said plurality of object information related to said plurality of parameters are encoded in said predefined island artifact by adding a plurality of data objects related to said plurality of parameters in said body portion.

8. A method of encoding a plurality of parameters of an object in a three dimensional CAD model using a CAD model information encoder tool, said method comprising:
a) generating, using a CAD module, said three dimensional CAD model, wherein said CAD module comprises a header encoding module and a body encoding module to encode said plurality of parameters;
b) including a plurality of vertices and a plurality of faces in a body portion of said three dimensional CAD model;
c) encoding, using said header encoding module, said plurality of parameters declared in said three dimensional CAD model using said plurality of existing parameters;
d) including a plurality of object information related to said plurality of parameters in said body portion of said three dimensional CAD model;
e) encoding, using said body encoding module, said plurality of object information related to said plurality of parameters in said predefined island artifact; and
f) displaying, by a display unit, said plurality of parameters and said plurality of object information related to said plurality of parameters encoded in said three dimensional CAD model.

9. The method of claim 8, further comprising storing said predefined island artifact of said three dimensional CAD model in a database.

10. The method of claim 8, wherein said predefined island artifact is a tetrahedron artifact.
